(19) United States
(12) Patent Application Publication
(10) Pub. No.: US 2022/0227680 A1
(43) Pub. Date: Jul. 21, 2022

(54) BUFFERED COCO MATERIAL

(71) Applicant: GENUS INDUSTRIES, LLC dba ICOIR PRODUCTS GROUP, Oregon City, OR (US)

(72) Inventor: DAVID SHOUP, OREGON CITY, OR (US)

(21) Appl. No.: 17/153,614

(22) Filed: Jan. 20, 2021

(51) Int. Cl. C05G 1/00; C05F 5/00; C05C 5/04; C05C 5/00

(52) U.S. Cl. CPC C05G 1/00; C05C 5/005; C05C 5/04; C05F 5/002

(57) ABSTRACT

A method of buffering coco material includes cleaning a quantity of untreated coco material to result in cleaned coco material, applying buffered water to the cleaned coco material to produce treated coco material, aging the treated coco material to produce aged coco material, and cleaning the aged material to produce buffered coco material.

### TECHNICAL FIELD

This disclosure relates to supplements for the garden industry, more particularly to supplements using coconut coir husk media.

### BACKGROUND

Widespread use of calcium and magnesium supplements in the indoor gardening industry indicates that many growers have discovered the cation exchange capacity (CEC) phenomenon in coconut coir husk media, referred to here as coco or coir. The CEC provides a measure of the degree to which a growing media can adsorb and exchange cations. Cations are positively charged ions, such as calcium, magnesium, potassium, sodium ions, sodium hydroxide, hydrogen and aluminum. Growers are trying to correct deficiencies in their growth media by adding calcium and magnesium supplements.

The CEC value is typically expressed as milli-equivalent (meq) per 100 grams. An equivalent is the weight in grams of a molecule divided by its molecular weight (grams per mol of the substance), multiplied by its charge. For example, hydrogen (H) has a one plus positive charge (+), has a molecular weight of 1. One gram of hydrogen is one equivalent. Calcium has a molecular weight of 40 g and a two plus positive charge. Therefore, 40 grams of calcium is two equivalents. Being in solution provides the liters. For example, if a solution has 30 mgs of NaCl in 400 mL of solution, and the molecular weight of NaCl is 58.44 g/mol. NaCl separates in sodium⁺ and Cl⁻. The result is then [(30 mg)*2)]/58.44 equals 1.027 mEq/liter. Products want to exchange undesirable salts for desirable ions.

The measure of electrical conductivity (EC) captures the level of total dissolved salts in the media. Each type of plants has different needs, but in general most grow media should have an EC of less than 1.0 mS/cm with test method EC_{1:1.5}. This method measures 1 part coco to 1.5 parts distilled water. After agitating the coco, the mix settles and an EC meter measures the EC. However, hydroponics applications may use media with EC as low as 0.30 mS/cm. All measures of EC used in this discussion are by the EC_{1:1.5} method.

Previous approaches of adapting coir typically involve washing to obtain an EC of 1 or 1.6. Currently, only higher quality and higher priced coco products undergo washing multiple times and have an EC or 0.7 or lower. A goal of these product aims to significantly lower the percentage of CEC sites that have potassium and sodium and increase the percentage of sites that have calcium and magnesium.

### DETAILED DESCRIPTION OF THE EMBODIMENTS

Embodiments here provide coir as a plant growth media where the coir has undergone buffering to increase the amounts of magnesium and calcium while reducing the amounts of salts. Untreated, raw, natural cocopeat coir material is burdened with sodium and potassium and very low in calcium and magnesium. The “buffering” of coir material is essential to balance the calcium and magnesium against the potassium and sodium levels.

High sodium and potassium with very low calcium and magnesium slows plant growth. The media attempts to pull calcium from the plant while increased calcium and magnesium promotes the opposite response from plants. Plants also like a little potassium but the balance needs to be correct and coir naturally has too much potassium. Swimming pool lined with gunite concrete sides are a good example. If the calcium hardness level of water within the pool is lower than the calcium level of the gunite walls, the pool water will pull calcium from the walls causing the walls to pit. Without a treatment focusing on calcium and magnesium within the coir material, the potassium tends to cause an imbalance in the nutrient soil mix and inhibits the uptake of calcium and magnesium, causing a reverse effect.

As user here, the terms “coir” and “coco” refer to loose coconut husk material, typically shredded, which may be mixed with inner husk pith materials. “Rinsing” refers to washing or rinsing the coir with water. Generally this reduces the salts that reside in the coir material. “Buffering” means a process that alters the CEC of the coir, typically through the addition of nutrients. Measures of EC used here are by the EC_{1:1.5} method mentioned above.

Coir particles comprise natural organic matter having negative charges on their surfaces that attract cations. As discussed above, CEC measures the quantity of nutrients the media can absorb and retain before the nutrients can leach out. Coir often has a CEC in the range of 90-100 meq/100 g of media. The CEC profile of coir is naturally loaded with potassium and sodium, with little or no calcium or magnesium. The magnesium is present in the raw material and low trace amounts obtained from the water rinse source.

The embodiments here significantly lower the percentage of CEC sites that have potassium and sodium attached and increase the percentage of CEC sites that have calcium and magnesium attached. Prior to treatment, coir may have potassium attached to approximately 40% of the sites and sodium to 15% of the sites. If the 40% of the unbuffered coir holds potassium, that equals 40 meq/100 g of media that has potassium.

While it may not seem like much, but this represents a high amount of potassium, most of which will slowly release into the aqueous solution around a plant's roots. Well-balanced feed would have about 0.22 g of potassium per liter of solution. The above potassium profile would equal about 1.56 g of potassium per liter. Sodium may exist in the unbuffered coir up to 0.35 g per liter. This results in an unbalanced nutrient solution.

Generally the embodiments involve buffering coir media by exposing the cation exchange to a solution of low EC water with high concentrations of the desired cations. In these embodiments, this typically means calcium and magnesium. As discussed above, some approaches wash the coco with water, even low EC water, but not with the concentrations of the desired ions. The washing will eliminate some of the salts, lowering the EC, but does not alter the CEC. The cations in the solution will adsorb at different levels. Calcium and magnesium will adsorb twice as fast as potassium and magnesium because they are plus two charged cations, compared to the plus one cations of potassium and magnesium.

In some embodiments, the process buffers coco material with 8 kg of calcium nitrate per cubic meter of coco material. Calcium nitrate has a value of about 19% calcium, which equals 1,520 g of calcium with almost no magnesium, potassium, or sodium if the water is clean.

A high concentration of calcium molecules attaches to the media as each calcium molecule is adsorbed, two molecules of potassium or sodium are released because calcium has a double-plus charge and potassium and sodium are single-plus charges.

In the beginning the exchange goes very quickly, but as the exchange continues, the concentration of the potassium and sodium molecules released into the solution slows the exchange down and it eventually comes into equilibrium. The buffering process can be done in 10-15 minutes to the point at which the exchange slows down enough that the greater exchange is not worth the wait.

Some embodiments have coco products buffered with a higher treatment of calcium and magnesium concentration. This creates a lower potassium and sodium percentage on the exchange and adds the benefits of calcium and magnesium to the CEC. These more advanced buffering processes involve a much greater amount of time, but result in much lower potassium and sodium levels on the exchange. This essentially creates a better coco product from day one, ensuring a nutrient mix goes straight to the plant versus amending the coco peat CEC. The CEC of coco, if un-buffered, can tend to be too high in sodium (Na) and potassium (K) and too low in Calcium (Ca) and Magnesium (Mg). Some potassium is good for plant growth. Too much potassium will result in too little magnesium being available for the plant. Too much sodium is a bad situation, especially to young and bare root plants. Coco, being of the coconut tree, can have a very high level of salts. They often grow along coasts and absorb salt from the water that they grow by.

The words “buffer” and “rinse” in regards to coco are sometimes used synonymously. It should be noted that simply rinsing coco with water will not serve to buffer it. Rinsing the coco coir may well remove some of the water-soluble available salts that are in it, but it will not by itself alter the CEC of the coir. Additional nutrients will need to be added in order to feed the plants.

Starting with unprocessed coconuts, the process first separates the coconut husks from the inner hard shell nut. Next, the process shreds the husk material into a fully loose material. The process then separates the larger/longer fiber coir strands and outer husk soft skin from the inner short fiber coir strands and small pith media particles. The process then collects the smaller length fiber strands and pith particle media for processing into buffered material. In one embodiment the shorter length strands comprise those that are shorted than 20 mm.

The collected material then undergoes screening to screen non-coco matter from the material, including outer husk skin shell material, fibers outside a desired length and pith material smaller than a desired size. In some embodiments, this means fibers larger than 20 mm, below 10% and pith material fines smaller than 0.50 mm are removed. This allows for higher material expansion and absorption per kg of volume. This discussion refers to the collected material as untreated coco or material.

The process than soaks the untreated material. In one embodiment, the material may soak in water having a desired EC level, such as one lower than 0.70 mS/cm (milliSiemens per centimeter). The material may undergo multiple soaks, resulting in cleaned material. The cleaned material then undergoes buffering by addition of nutrients such as calcium and magnesium. In some instances, the magnesium is not necessarily added, but the treatment makes magnesium resident in the material more accessible to the sites.

The process uses what will be referred to here as “buffered water.” This means water than has the desired ions in it. Buffered water results from having the desired ions mixed into it. For example, one could mix calcium nitrate (Ca(NO₃)₂) into low EC water. In one embodiment, the process mixes 19% calcium nitrate at a ratio of 8 Kilos per 1,000 liters of water. The water used may have an EC level less than 0.30 mS/cm. Mixing the buffered water may occur at any point in the process. The calcium nitrate used consisted of totally soluble calcium nitrate. Field grade calcium nitrate may also work, but may need to undergo agitation to dissolve the particles sufficiently.

The process then buffers the cleaned material by applying the buffered water. In one embodiment, the process applies the buffered water at a ratio of 200 liters of buffered water per 1 cubic meter of coco. In another embodiment 1,000 liters of water mixed with 7 kg of calcium nitrate buffers 5 cubic meters of coco.

The application of the buffered water to the coco may occur in many different ways. In one embodiment an overhead sprinkler system administers the treated or untreated water to the coco over a 24 hour period by regulating the water flow from the sprinkler system. This results in an intermediate material referred to here as treated material or treated coco. If one does not have a suitable sprinkler system, the process can soak the material in the buffered water and ensuring that the buffered water and the clean material mix well.

After application of the buffered water to the coco, resulting in treated material or coco, the treated coco then undergoes an aging period depending upon the amount of buffered water, element levels and the amount of coco. The aging period may range from 1-24 hours. The aging period enables buffering to take full effect and for optimum results, resulting in aged material or coco.

Once the aged material has complete the aging period, the aged material undergoes rinsing one or more times with clean water having an EC level of no higher than 0.30 mS/cm. This results in buffered cocopeat.

### Example 1

In one example, 19% calcium nitrate was mixed into water have an EC of less than 0.3 mS/cm at a ratio of 8 kilos per 1,000 liters of water to produce buffered water. The coco was washed by soaking in a basin with water having an EC lower than 0.7 mS/cm. The buffered water was applied to the cleaned coco over a 24 hour period with an overhead sprinkler system. The treated material was then aged for 24 hours, and the resulting aged material washed with water having an EC of less than 0.3 mS/cm. The resulting buffered coco has the following characteristics:
pH 5.5> to <6.58;
EC less than 0.4 mS/cm;
Potassium 100-150 ppm;
Magnesium 70-150 ppm;
Calcium 100-200 ppm; and
Sodium 50-80 ppm.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the embodiments.

What is claimed is:

1. A method of buffering coco material, comprising:
cleaning a quantity of untreated coco material to result in cleaned coco material;
applying buffered water to the cleaned coco material to produce treated coco material;
aging the treated coco material to produce aged coco material; and
cleaning the aged material to produce buffered coco material.

2. The method as claimed in claim 1, further comprising producing untreated coco material by:
separating coconut husks from an inner hard shell nut;
shredding the husk material into a loose material; and
screening the loose material to collect fibers within a desired length and pith particles having a desired size as the untreated material.

3. The method as claimed in claim 2, wherein the desired length is larger than 20 mm and the desired pith particle sizes are greater than 0.55 mm.

4. The method as claimed in claim 1, further comprising producing buffered water by mixing calcium nitrate into water having an electrical conductivity lower than 0.3 mS/cm.

5. The method as claimed in claim 4, wherein mixing calcium nitrate into water comprises mixing 19% calcium nitrate into water.

6. The method as claimed in claim 4, wherein mixing calcium nitrate into water comprises mixing 7 kilograms of calcium nitrate mixed into 1000 liters of water.

7. The method as claimed in claim 4, wherein mixing calcium nitrate into water comprises one of mixing totally soluble calcium nitrate into water, or mixing field grade calcium nitrate into water and agitating the mixture to dissolve the calcium nitrate.

8. The method as claimed in claim 1, wherein applying buffered water comprises applying 200 liters of buffered water per 1 cubic meter of coco.

9. The methods as claimed in claim 1, wherein aging the treated coco material comprises aging the treated coco material for an aging period in the range of 1 to 24 hours.

10. The method as claimed in claim 1, wherein cleaning the aged coco material comprises rinsing the aged coco material one or more times in water having an EC of lower than 0.30 mS/cm.
